(19) United States
(12) Patent Application Publication
(10) Pub. No.: US 2025/0297351 A1
(43) Pub. Date: Sep. 25, 2025

(54) LASER-ASSISTED REAGENT ACTIVATION AND PROPERTY MODIFICATION OF SELF-PASSIVATING METALS

(71) Applicant: Swagelok Company, Solon, OH (US)

(72) Inventors: Michael D. Bestic, Lyndhurst, OH (US); Cyprian Adair William Illing, Cleveland Heights, OH (US); Peter C. Williams, Cleveland Heights, OH (US); Ronald S. Edmonson, Munroe Falls, OH (US); Todd Johns, Solon, OH (US); Christina Semkow, University Heights, OH (US); Joshua Alan Gress, Twinsburg, OH (US)

(21) Appl. No.: 18/868,808

(22) PCT Filed: May 25, 2023
(86) PCT No.: PCT/US2023/067444

§ 371 Date: Nov. 25, 2024

Related U.S. Application Data
(60) Provisional application No. 63/348,065, filed on Jun. 2, 2022.

(51) Int. Cl. C23C 8/74

(52) U.S. Cl. CPC C23C 8/74

(57) ABSTRACT

Disclosed herein is a method for treating an article made of self-passivating metal including applying reagent to a surface portion of the article and applying laser light to the surface portion of the article to chemically activate the reagent, wherein the chemical activating of the reagent treats the surface portion for modification of one or more properties.

### RELATED APPLICATIONS

This application claims priority to and all benefit of U.S. Provisional Patent Application Ser. No. 63/348,065, filed on Jun. 2, 2022, for LASER-ASSISTED REAGENT ACTIVATION AND PROPERTY MODIFICATION OF SELF-PASSIVATING METALS, the entire disclosure of which is incorporated herein by reference.

### FIELD OF THE DISCLOSURE

This disclosure relates to materials and methods involved in surface treatment of metals using laser activation. This activation may occur after the metal is worked or wrought. It may also be applied to articles produced via additive manufacturing. Specifically, this disclosure relates to processes and methods for treating the surface of a metal article by using laser heating of the metal surface and/or a chemically active reagent to modify one or more mechanical, chemical, and/or electrical properties of at least a portion of the surface of metal articles.

### BACKGROUND

### Low Temperature Carburization

Case hardening is a widely used industrial process for enhancing the surface hardness of shaped metal articles. For example, carburizing is a typical commercial process used to harden shaped metal articles. In carburizing, the shaped metal article is contacted with a gaseous carbon compound at elevated temperature whereby carbon atoms liberated by decomposition of the carbon compound diffuse into the article's surface. Hardening occurs through the reaction of these diffused carbon atoms with one or more metals in the workpiece (herein the terms “workpiece” and “article” are used interchangeably) thereby forming distinct chemical compounds, i.e., carbides, followed by precipitation of these carbides as discrete, extremely hard, crystalline particles in the metal forming the workpiece's surface. See Stickels, “Gas Carburizing”, pp 312 to 324, Volume 4, ASM Handbook, © 1991, ASM International.

In the mid 1980's, a technique for case hardening stainless steel was developed in which the shaped metal article is contacted with a carburizing gas at low-temperature, typically below 500° C. (932° F.). At these temperatures, and provided that carburization does not last too long, carbon atoms diffuse into the shaped metal article surfaces, typically to a depth of 20-50 μm without formation of carbide precipitates. Nonetheless, an extraordinarily hard case surface layer can be obtained, which is believed due to the stress placed on the crystal lattice of the metal by the diffused carbon atoms. Moreover, because carbide precipitate presence is minimal, the corrosion resistance of the steel is unimpaired, even improved.

This technique, which is referred to as a “low-temperature carburization,” is described in a number of publications including U.S. Pat. Nos. 5,556,483, 5,593,510, 5,792,282, 6,165,597, 6,547,888, EPO 0787817, Japan 9-14019 (Kokai 9-268364) and Japan 971853 (Kokai 9-71853). The disclosures of these documents are incorporated herein by reference.

### Nitriding and Carbonitriding

In addition to carburization, nitriding and carbonitriding can be used to surface harden various metals. Nitriding works in essentially the same way as carburization except that, rather than using a carbon-containing gas which decomposes to yield carbon atoms for surface hardening, nitriding uses a nitrogen containing gas which decomposes to yield nitrogen atoms for surface hardening.

In the same way as carburization, however, if nitriding is accomplished at higher temperatures and without rapid quenching, hardening occurs through the formation and precipitation of discrete compounds of the diffusing atoms, i.e., nitrides. On the other hand, if nitriding is accomplished at lower temperatures without plasma, hardening occurs without formation of these precipitates through the stress placed on the crystal lattice of the metal by the nitrogen atoms which have diffused into this lattice. As in the case of carburization, stainless steels are not normally nitrided by conventional (high temperature) or plasma nitriding, because the inherent corrosion resistance of the steel is lost when the chromium in the stainless steel reacts with the diffusion nitrogen atoms to cause nitrides to form.

Recent testing of low-temperature nitrocarburization has shown effective surface hardening for austenitic alloys by low-temperature nitrocarburization using solid reagent precursors. See U.S. Pat. No. 10,214,805 and U.S. patent application Ser. No. 17/242,555, the entirety of each of which is incorporated herein by reference. The surface hardening process infuses a large amount of carbon and nitrogen into the surface of the shaped metal article. The interstitial carbon and nitrogen substantially increase hardness, corrosion resistance, and fatigue resistance of the treated article. Additionally, if carried out at slightly elevated temperatures around 500° C., a precipitate layer may form on the part surface, further increasing hardness in that region. The sensitization effect (diminished corrosion resistance) common to these alloys in precipitated regions is offset by the surrounding treated material which has superior corrosion resistance relative to the base alloy. Additionally, the surface treatment produces a high compressive stress which may close pores and mitigate similar defects.

In carbonitriding, also referred to and used interchangeably herein as “nitrocarburizing,” the workpiece is exposed to both nitrogen and carbon-containing gases, whereby both nitrogen atoms and carbon atoms diffuse into the workpiece for surface hardening. In the same way as carburization and nitriding, carbonitriding can be accomplished at higher temperatures, in which case hardening occurs through the formation of nitride and carbide precipitates, or at lower temperatures in which case hardening occurs through the sharply localized stress fields that are created in the crystal lattice of the metal by the interstitially dissolved nitrogen and carbon atoms that have diffused into this lattice. For convenience, all three of these processes, i.e., carburization, nitriding and nitrocarburizing (carbonitriding), are collectively referred to in this disclosure as “low-temperature case formation,” “low-temperature surface hardening,” “low-temperature surface hardening processes,” or “hardening processes.”

### Role of Reagents in Hardening

Because the temperatures involved in low-temperature surface hardening are so low, carbon and/or nitrogen atoms may not penetrate the outer passive layers of certain metals like stainless steel. Therefore, low-temperature surface hardening of these metals is normally preceded by a step in which the shaped metal article is contacted with a halogen containing gas such as HF, HCl, NF₃, F₂ or Cl₂ at elevated temperature, e.g., 200 to 400° C., to make the steel's protective oxide coating transparent to the passage of carbon and/or nitrogen atoms (making the protective oxide coating transparent to the passage of carbon and/or nitrogen atoms is also known and referred to herein as “activating” and “depassivating”). The halide gas chemistry reduces the passive oxide film which then makes it “transparent” to the nitrogen and carbon atoms. The passive film is already optically transparent since it is only angstroms thick.

### Surface Preparation and the Beilby Layer

Low temperature surface hardening is often done on workpieces with complex shape. To develop these shapes, some type of metal shaping operation is usually required such as a cutting step (e.g., sawing scraping, machining) and/or a wrought processing step (e.g., forging, drawing, bending, etc.). As a result of these steps, structural defects in the crystal structure as well as contaminants such as lubricants, moisture, oxygen, etc., are often introduced into the near-surface region of the metal. As a result, in most workpieces of complex shape, there is normally created a highly defective surface layer having a plastic deformation-induced extra-fine grain structure and significant levels of contamination. This layer, which can be up to 2.5 μm thick and which is known as the Beilby layer, forms immediately below the protective, coherent chromium oxide layer or other passivating layer of stainless steels and other self-passivating metals.

As indicated above, the traditional method for activating stainless steels for low temperature surface hardening is by contact with a halogen containing gas. These activating techniques are essentially unaffected by this Beilby layer.

However, the same cannot be said for the self-activating technologies described in the above-noted disclosures by Somers et al. and Christiansen et al. in which the workpieces are activated by contact with acetylene or an “N/C compound.” Rather, experience has shown that, if a stainless steel workpiece of complex shape is not surface treated by electropolishing, mechanical polishing, chemical etching or the like to remove its Beilby layer before surface hardening begins, the self-activating surface hardening technologies of these disclosures either do not work at all or, if they do work somewhat, produce results which at best are spotty and inconsistent from surface region to surface region.

See, Ge et al., The Effect of Surface Finish on Low-Temperature Acetylene-Based Carburization of 316L Austenitic Stainless Steel, METALLURGICAL AND MATERIALS TRANSACTIONS B, Vol. 458, December 2014, pp 2338-2345, ©2104 The Minerals, Metal & Materials Society and ASM International. As stated there, “[stainless] steel samples with inappropriate surface finishes, due for example to machining, cannot be successfully carburized by acetylene-based processes.” See, in particular, FIG. 10(a) and the associated discussion on pages 2339 and 2343, which make clear that a “machining-induced distributed layer” (i.e., a Beilby layer) which has been intentionally introduced by etching and then scratching with a sharp blade cannot be activated and carburized with acetylene even though surrounding portions of the workpiece which have been etched but not scratched will readily activate and carburize. As a practical matter, therefore, these self-activating surface hardening technologies cannot be used on stainless steel workpieces of complex shape unless these workpieces are pretreated to remove their Beilby layers first.

To address this problem, U.S. Pat. No. 10,214,805 discloses a modified process for the low temperature nitriding or carbonitriding of workpieces made from self-passivating metals in which the workpiece is contacted with the vapors produced by heating a reagent that is an oxygen-free nitrogen halide salt. As described there, in addition to supplying the nitrogen and optionally carbon atoms needed for nitriding and carbonitriding, these vapors also are capable of activating the workpiece surfaces for these low temperature surface hardening processes even though these surfaces may carry a Beilby layer due to a previous metal-shaping operation. As a result, this self-activating surface hardening technology can be directly used on these workpieces, even though they define complex shapes due to previous metal-shaping operations and even though they have not been pretreated to remove their Beilby layers first.

### Additive Manufacturing

“Additive manufacturing” (AM, and also referred to as 3D-printing) differs from more conventional manufacturing processes in that it forms 3D objects by adding layer-upon-layer of materials, rather than machining or molding a bulk material or forming via mold. A wide range of materials may be used in AM depending on the specific techniques employed. Plastics and ceramics, for example, may be 3D-printed or “jetted.” Certain polymers may be formed via extrusion or laser sintering. Metal layers or sheets may be laminated together to create a 3D shape. Powdered metals may be fused together by AM to create additive parts. The present disclosure primarily concerns the latter, i.e., metallic materials formed from AM.

Metallic AM generally begins with fusing particles of a powdered metal to create individual layers of the target structure. Fusing techniques vary. They include laser or electron beam powder bed fusion (L-PBF or EB-PBF, respectively) techniques, and a laser deposition technique called direct energy deposition (DED). Metal fused deposition modeling (FDM) uses filaments infused with metal powders and binder to print 3D “green” bodies that are subsequently sintered to densify the powders. Other techniques often applied to AM articles after 3D-printing include hot isostatic pressing (HIP), primarily for densification and reduction of porosity.

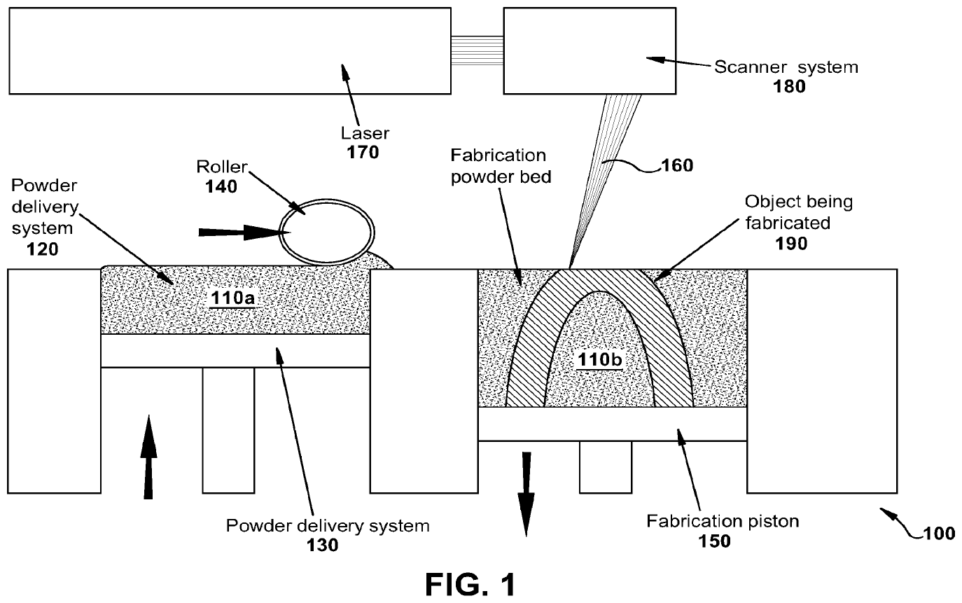

An exemplary laser powder bed fusion process 100 appears in FIG. 1. As shown in FIG. 1, metal powder 110a is provided via a powder delivery system 120. A piston 130 pushes the powder 110a upward. A roller 140 moves the powder 110a laterally toward the fabrication piston 150. Once the powder enters the fabrication powder bed, the powder 110b rests on the fabrication piston 150. Then light 160 from laser 170 is applied to fuse powder particles together. A scanner system 180 moves the light beam 160 such that it traces a shape of the object 190 being fabricated in the powder 110b. Generally, one layer of the object 190 is traced at a time. The fabrication piston 150 continuously or stepwise lowers the object 190 so that completed layers can be moved out of the way of the laser and so new layers can be fabricated. [0007] In addition to the above, AM may include “subtractive manufacturing” (SM). SM is a machining process in which solid piece of raw material is carved into a desired 3D geometrical shape and size by using a controlled material-removal process. This process relies heavily upon the use of machine tools in addition to power and hand tools. It may also include laser or other cutting tools. To the extent that any of these processes cause plastic deformation of the surface of the article, they may introduce layers of deformation (e.g., Beilby layers). As described herein and in the references incorporated herein, the techniques of the present disclosure can harden materials both with or without the existence of such layers of deformation.

Additive manufacturing allows for the design of complex flow paths and unique geometries not possible using other manufacturing methods. However, this increased design freedom comes at a cost. For example, residual porosity in AM parts, resulting from incomplete particle fusion, may undermine mechanical strength and degrade corrosion resistance. Although these properties may be improved through post-processing heat treatments (e.g., HIP), the heat treatments also come at a cost. They are typically run at high temperatures and pressures, typically resulting in an annealed material with lower yield strength.

Although the laser powder bed fusion process described above can make ferrules and components for other mechanical applications, hardening the outer surface of those components presents new challenges. Many treatments used to harden materials in conventional manufacturing do not readily apply to AM materials. Therefore, new ways of controlling the properties of the materials used in AM are needed.

### DETAILED DESCRIPTION

As discussed above, most treatment methods apply reagent to the workpiece surfaces targeted for treatment via contact and/or placing the reagent in close proximity to the article or workpiece and heating the environment surrounding the entire article or workpiece. Such techniques can have the disadvantage of not being able to specifically target particular surfaces of the article or workpiece, or particular portions of article or workpiece surfaces, for treatment. They further have the disadvantage of requiring hours or days to complete heating and treatment. Many of the methods treat all exposed article or workpiece surfaces the same way, even when the surfaces do not have an equal need for treatment. Thus, there is a need for a way to selectively apply reagent to particular surfaces, or particular portions of article or workpiece surfaces, targeted for selective treatment. There is a further need to apply localized heating to applied reagent, such as via laser, to activate and harden the article or workpiece locally and with precision. There is a still further need to apply the treatment in such a way that does not require hours or days, but rather minutes or seconds.

The present disclosure concerns methods of treating an article, primarily using laser light and targeted focused reagent for activating portions of the article. The laser light and reagent can be applied to specific portions of the article over relatively short periods of time (e.g., seconds or minutes as opposed to days or hours) to effect a modification in the article that facilitates property change where the reagent is present. Examples of such properties modified in the article's surface include enhancing corrosion resistance, mechanical properties, electrical resistance, and other properties.

### Overview of Setup 200

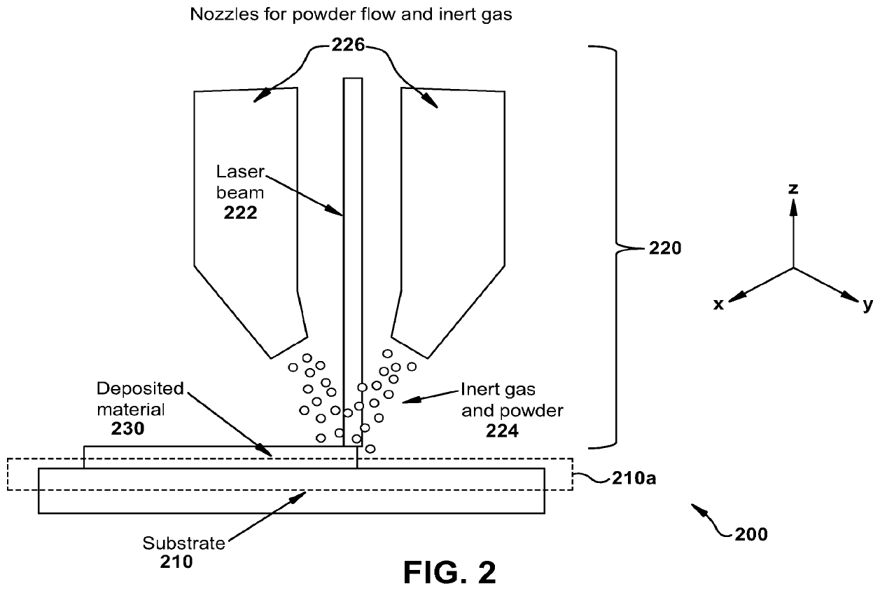

FIG. 2 shows one exemplary set up 200 that may apply laser light and reagent accordance with the present disclosure. Is to be understood that the setup 200 is merely exemplary and shows general principles that may be used in conjunction with the present disclosure. Other setups and arrangements are possible, include those that vary the position of the laser 222 with respect to an article 210, the delivery method of the reagent (e.g., via nozzle 226 and powder/gas 224), and the relative positioning of any components that are shown is setup 200.

FIG. 2 shows treating a surface 201a of a substrate 210. In some cases, substrate 210 may be an article and surface 210a may be an outer surface of the article 210. Here the terms “component,” “substrate,” “article,” and “workpiece” will be used interchangeably. However, it is to be understood that substrate 210 is not limited to metal having any particular type of preparation. For example, article 210 may include worked or wrought metal. Article 210 may include metal that has been additively manufactured and/or formed without cold or hot working.

Article 210 is generally a metal article that may or may not be mechanically worked or formed (e.g., AM formed) into a shape suitable for a particular application. As described in more detail below, the metal of the article 210, in certain cases, may be self-passivating. Article 210's passivation layer may be present at surface 210a. It may be formed of an oxide, such as a chromium oxide or a titanium oxide, or combination thereof. Article 210 and/or surface 210a may include a Beilby layer and/or other layer resulting from working or application of mechanical force.

Materials That Article 210 May Comprise

Article 210 may comprise exemplary metals including alloys comprising a stainless steel, particularly stainless steel having 5-50 wt. % Ni and at least 10 wt. % Cr, a nickel-based alloy, and a cobalt-based alloy. Article 210 may include a high-manganese stainless steel, such as high-manganese steels having at least 10 wt. % Cr or a titanium-based alloy. Article 210 may preferably include one or more of the following alloys: 316L, 6Mo, 6HN, Incoloy 825, Inconel 625, Hastelloy C22, and Hastelloy C276.

Article 210 may comprise other steels, especially stainless steels. Exemplary steels include 384SS, alloy 254, alloy 6HN, etc., as well as duplex alloys, e.g. 2205. The treatments disclosed herein may be applied to nickel alloys, nickel steel alloys, Hastelloy, nickel-based alloys. Exemplary nickel-based alloys include alloy 904L, alloy 20, alloy C276, etc. The treatments may also be applied to, cobalt-based alloys, manganese-based alloys and other alloys containing significant amounts of chromium, e.g., titanium-based alloys. However, they are not limited to such materials, and can apply to metals. In some variations, they may also be applied to non-metals.

Stainless steels that may be incorporated into article 210 include those containing 5 to 50, preferably 10 to 40, wt. % Ni and enough chromium to form a protective layer of chromium oxide on the surface when the steel is exposed to air. That includes alloys with about 10% or more chromium. Some contain 10 to 40 wt. % Ni and 10 to 35 wt. % Cr. Examples include the AISI 300 series steels such as AISI 301, 303, 304, 309, 310, 316, 316L, 317, 317L, 321, 347, CF8M, CF3M, 254SMO, A286 stainless steels, and AL-6XN. The AISI400 series stainless steels and Alloy 410, Alloy 416 and Alloy 440C are included. Cobalt-based alloys and high-manganese stainless steels may be included, particularly those with at least 10 wt. % Cr or a titanium. The surface 210a of the metal may have a passivating coating, e.g., a continuous passivating coating, formed either from chromium-rich oxide or titanium-rich oxide. As a result of a metal shaping operation, the metal may have one or more distinct defect-rich subsurface zones (e.g., that constitute a Beilby layer). The metal may include, but is not limited to: 316L (UNS S31600), 6Mo (UNS S31254), 6HN (UNS N08367), Incoloy 825 (UNS N08825), Inconel 625 (UNS N06625), and Hastelloys C22 (UNS N06022) or C276 (UNS N10276).

Other types of alloys that can be treated according to this disclosure are the nickel-based, cobalt based and manganese-based alloys, including those containing enough chromium to form a coherent protective chromium oxide protective coating when exposed to air, e.g., about 10% or more chromium. Examples of such nickel-based alloys include Alloy 600, Alloy 625, Alloy 825, Alloy C-22, Alloy C-276, Alloy 20 Cb and Alloy 718, to name a few. Examples of such cobalt-based alloys include MP35N and Biodur CMM. Examples of manganese containing alloys include AISI 201, AISI 203EZ and Biodur 108. Still other alloys treated according to this disclosure include titanium-based alloys. These alloys may form titanium oxide coatings upon exposure to air which inhibit the passage of nitrogen and carbon atoms. Specific examples of such titanium-based alloys include Grade 2, Grade 4 and Ti 6-4 (Grade 5). Alloys based on other self-passivating metals such as zinc, copper and aluminum can also benefit from treatments disclosed herein. Tool steels (e.g., those used in stamping dies) may also be included. Examples of suitable tool steels include hardened tungsten-chromium-vanadium-based alloys, and their variants.

The treatments can be applied to metals of any phase structure including, but not limited to, austenite, ferrite, martensite, duplex metals (e.g., austenite/ferrite), etc.

It is to be understood that the treatments herein may be used with worked materials, as described above. The article 210s may be at least one of a cast, wrought, work hardened, precipitation hardened, partially annealed, fully annealed, formed, rolled, forged, machined, welded, additively manufactured, powder metal sintered, hot isostatic pressed, and stamped. They may also be applied to materials that are not worked. Components 210 within this disclosure may or may not include a Bielby layer. They may be work hardened, and/or precipitation hardened. Further, they may be formed, rolled, forged, machined, or subtractive manufactured. They may be substantially free of heavy oxide scale and contamination.

This disclosure can be carried out on any metal or metal alloy which is self-passivating in the sense of forming a coherent protective chromium-rich oxide layer upon exposure to air which is impervious to the passage of nitrogen and carbon atoms. The metal components 210 may alternatively not be self-passivating. These metals and alloys are described for example in patents that are directed to low-temperature surface hardening processes, examples of which include U.S. Pat. Nos. 5,792,282, 6,093,303, 6,547,888, EPO 0787817 and Japanese Patent Document 9-14019 (Kokai 9-268364). Treatments of this disclosure can also be applied to materials that do not form passivation layers.

Treatments described herein can be applied not only to wrought metal alloys, but also to article 210s or articles created by other techniques include additive manufacturing (AM) and 3D printing. Such article 210s or articles may be sintered via laser (e.g., by selective laser sintering (SLS)), for example. These article 210s or articles may be additive manufactured in whole or in part. They may also be hot isostatic pressurized, formed, rolled, forged, machined, or subtractive manufactured.

### Application Device 220 and Laser 222

FIG. 2 shows an application device 220, which may apply a laser light 222 and or reagent 224 or other chemical. Although FIG. 2 shows application of device 220 adding a particular form, it is to be understood that application device 220 to take on any suitable form. For example, the application device 220 may include the laser beam 222 (also referred to as “laser light” herein) and nozzles 226 for applying gas or powder 224 to surface 210a, as shown in FIG. 2. It is to be understood that other configurations are possible, including those that separate laser 222 from nozzles 226 and/or use any suitable number of lasers 222 or nozzles 226. Although FIG. 2 shows nozzles 226 delivering a single gas or powder 224, it is to be understood that nozzles 226 may be configured to deliver different powder or gas 224. Device 220 may apply laser light 222 and powder/gas 224 simultaneously and/or concurrently. Applying the laser light 222 may cause a chemical reaction in the article 210.

As shown in FIG. 2, concurrently apply the gas or powder 224 as the laser 222 to surface 210a can create a layer of deposited material 230. The deposited material 230 may serve as a coating for the article 210. Coating 230 may alter properties of the surface 210a and/or article 210. Interaction between the laser light 222 and the gas or powder 224 may cause the gas or powder 224 to solidify to create the coating 230. The laser light 222 may also or alternatively, as discussed in more detail below, chemically activate the gas or powder 224 and/or the underlying article 210. Such may, for example, activate the gas or powder 224 for enabling a process (e.g., carburization, nitrocarburizing, or carbonitriding) the surface 210a of the article 210.

The application device 220 may include, as shown in FIG. 2, a jet of powder 224 formed in nozzle 226. Nozzle 226 may include a micro flow jet, for example. The jet may also include a jet of vapor or gas, or liquid. When element 224 is a powder, the flow through nozzle 226 may comprise a gas, e.g., an inert gas, for propelling the powder 224 under pressure. The inert gas may prevent oxidizing of the surface 210a under treatment. The pressure may be low, moderate, or high pressure.

With respect to treatments described below including application of carbon and nitrogen, applying powder/gas 224 (e.g., including reagent) and/or laser light 222 may minimize carbide and nitride precipitation in the surface 210a and/or article 210. Applying powder/gas 224 (e.g., including reagent) and/or laser light 222 may further render any carbide and nitride precipitates produced to be finely, as opposed to coarsely, dispersed.

Laser 222 may take on a number of suitable forms and provide a number of different kinds of laser light. For example, laser 222 may provide co-linear coherent laser light. Laser 222 may include one or more of a fiber optic laser. Laser 222 may further include a gas laser, an excimer laser, an exciplex laser, a liquid-based laser, a dye-based laser, a chemical laser, a solid state laser, a chemical laser, a semiconductor laser, a diode-based laser; an infrared laser, and an ultraviolet laser. With regard to the gas, laser, the gas may include at least one of a CO₂, He, and Ne. With regard to a solid state laser, the laser may include at least one of a yttrium aluminum garnet (YAG) laser, a ruby laser, a soprano titanium laser, a soprano ice laser, and a titanium sapphire laser.

The effect of heating by laser 222 on surface 210a may vary. For example, the heating caused by the laser 222 may be sufficient to cause grain growth in metal grains in the article 210 and or its surface 210a. On the other hand, power in laser 222 may create insufficient heating to cause grain growth. Power in laser 222 may be sufficient to cause pyrolysis of powder/gas 224 (e.g., reagent).

Application device 220 may be part of a larger system. For example, a control system (not shown) may direct motion or movement of device 220. Application device 220 may be, for example, part of a 3D printing system or other printing system. Application device 220 may have freedom of movement in any of x, y, and z directions, as shown in FIG. 2. In particular, application device 220 may be moved according to a treatment plan and/or may be rastered, lowered, lifted, or translated in order to treat certain portions of article 210. Movement of device 220 may be controlled via computer, algorithm, or via user input (e.g., via joystick or other manual controls).

An area of surface 210a affected by the laser 222 and the powder/gas 224 may have surface area on order of cm², mm², or microns². The heating induced by laser 222 may be confined to this surface area. Alternatively, induced by laser 222 may extend beyond the surface area. For example, the heating created by laser 222 may include an area between the laser 222 and the surface area 210a.

As application device 220 moves across surface 210a, powder/gas 224 and laser light 222, device 220 may apply powder/gas 224 and/or laser light 222 to different portions of surface 210a. For example, device 220 may apply laser light 222 and/or powder/gas 224 to an end of the article 210 and not to others. In one example, application device 220 may apply laser light 222 and/or gas/power 224 to a portion of the article 210 that will, in the final deployment of the article 210, be exposed to mechanical contact and/or wear to alter the properties of the article 210 for the application. Such may include portions of article 210 that may mate or contact with other metals, e.g., in valve applications. In addition, the application of laser light 222 and powder/gas 224 may vary across the article 210. For example, it may be advantageous to vary a power, intensity, or wavelength of the laser light 222 on portions of the article 210 to cause properties of the article 210 to vary. In another example, it may be advantageous to vary a flux or intensity of powder/gas 224 flowing to portions of the surface 210a.

Surface treatment via applying powder/gas 224 (e.g., including reagent) and/or laser light 222 may occur over any suitable timescale. For example, treatment with powder/gas 224 (e.g., including reagent) and/or laser light 222 may occur over one minute or less. Treatment with powder/gas 224 (e.g., including reagent) and/or laser light 222 may occur over several minutes or hours. Treatment with powder/gas 224 (e.g., including reagent) and/or laser light 222 may occur over the following exemplary time frames: 0.2, 0.3, 0.4, 0.5, 0.6, 0.7, 0.8, 0.9, 1. 1.1, 1.2, 1.3, 1.4, 1.5, 1.6, 1.7, 1.8, 1.9, 2.0, 3.0, 4.0, 5.0, 10.0, 15.0, 30.0, 60.0 min. Treatment with powder/gas 224 (e.g., including reagent) and/or laser light 222 may occur over hours or days. Treatment with powder/gas 224 (e.g., including reagent) and/or laser light 222 and/or a hardening step may occur while article 210 is in at least one of a manufacturing and fabrication process, such as any of the manufacturing and fabrication processes described herein.

### Gaseous Environment of Setup 200

The environment of setup 200 may have a number of different variations. For example, setup 200 may include inert gas, nitrogen, argon, or other gas, e.g., noble gas. A pressure of gas in setup 200 may be 0.2 to 1.6 ATM, (including all subranges), or above. Setup 200 may be substantially in vacuum or ambient air.

Setup 200 may further include some level of oxygen. When setup 200 includes application of laser light 222 and the powder/gas 224 includes reagent, including oxygen gas may reduce an amount of waste reagent subsequent to any treatments applied to article 210. Such may occur because including oxygen helps to consume reagent during the treatments. Setup 200 may further include shielding gases which include gases that can diminish or prevent oxygen exposure and/or assist the work with a relatively small amount of oxygen by amplifying the effect of oxygen, etc. An exemplary shielding gas that may be used is nitrogen, other nitrogen containing gases (e.g., NH₃), and carbon containing gases (e.g., CO, C₂H₂, CH₄, etc.).

The level of oxygen gas in setup 200 may be any suitable level, e.g., 0.005 oxygen to other gas by volume ratio. Alternatively, setup 200 can be in a gaseous environment that is 0.005-0.010 oxygen to other gas by volume, 0.010-0.020 oxygen to other gas by volume, 0.020-0.030 oxygen to other gas by volume, 0.030-0.040 oxygen to other gas by volume, 0.040-0.050 oxygen to other gas by volume, 0.050-0.055 oxygen to other gas by volume, 0.055-0.060 oxygen to other gas by volume, 0.060-0.070 oxygen to other gas by volume, 0.070-0.080 oxygen to other gas by volume, 0.080-0.090 oxygen to other gas by volume, 0.090-0.100 oxygen to other gas by volume, 0.100-0.150 oxygen to other gas by volume, 0.150-0.200 oxygen to other gas by volume, 0.200-0.210 oxygen to other gas by volume, 0.210-0.220 oxygen to other gas by volume, 0.220-0.230 oxygen to other gas by volume, 0.230-0.240 oxygen to other gas by volume, 0.240-0.250 oxygen to other gas by volume, 0.250-0.260 oxygen to other gas by volume, 0.260-0.270 oxygen to other gas by volume, 0.270-0.280 oxygen to other gas by volume, 0.280-0.290 oxygen to other gas by volume, 0.290-0.300 oxygen to other gas by volume, 0.300-0.310 oxygen to other gas by volume, 0.310-0.320 oxygen to other gas by volume, 0.320-0.330 oxygen to other gas by volume, 0.330-0.340 oxygen to other gas by volume, 0.340-0.350 oxygen to other gas by volume, 0.350-0.360 oxygen to other gas by volume, 0.360-0.370 oxygen to other gas by volume, 0.370-0.380 oxygen to other gas by volume, 0.380-0.390 oxygen to other gas by volume, 0.390-0.400 oxygen to other gas by volume, 0.400-0.410 oxygen to other gas by volume, 0.410-0.420 oxygen to other gas by volume, 0.420-0.430 oxygen to other gas by volume, 0.430-0.440 oxygen to other gas by volume, and 0.440-0.450 oxygen to other gas by volume. Setup 200 can include a gaseous environment that is 0.005-0.450 oxygen to other gas by volume. As discussed above, it may also include shielding gases.

### Exemplary Reagents Used in Treatments of the Present Disclosure

As discussed above, the powder/gas 224 may comprise a “reagent,” such as any reagent discussed herein. These reagents include chemicals for increasing the influx of nitrogen and/or carbon to article 210 during any of the treatment processes described herein. Any suitable form of any reagent described herein may be used with this disclosure. This includes powder, liquid, gas and combinations thereof. As used herein, “reagents” includes any substance, including a non-polymeric N/C/H compound or other compounds used in the altering of metal surface properties and/or case formation. Reagent may be applied as a powder, liquid, or vapor. Reagent may be applied as a coating.

Setup 200 may expose article 210 to pyrolysis products of a nonpolymeric reagent comprising carbon and nitrogen. Pyrolysis may occur as a result of heating the reagent using laser 222 and/or another heat source (e.g., resistive and/or inductive heating). As such, treatments of the present disclosure may include exposing surfaces to a class of non-polymeric N/C/H compounds. Examples of suitable such reagents include a guanidine [HNC(NH₂)₂] moiety or functionality with or without an HCl association (e.g., complexing) for case formation. The guanidine moiety may or may not have a halide association. These reagents result in a case formation on the article 210 and improve hardening, corrosion resistance, and/or abrasion resistance.

In particular, results show that at least three reagents belonging to this system, 1,1-dimethylbiguanide HCl (hereinafter, “DmbgHCl”):

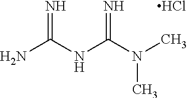

and guanidine HCl (hereinafter, “GuHCl”):

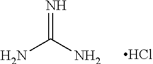

and biguanide HCl (BgHCl) have successfully induced extremely rapid surface hardening, and other surface property enhancements, such as other mechanical property enhancements (e.g., enhance Young's Modulus), as well as chemical property enhancements (e.g., enhance corrosion resistance), and electrical property enhancements, under low-temperature conditions. The guanidine [HNC(NH₂)₂] moiety or functionality with HCl complexing is the chemical structure common to both DmbgHCl, GuHCl, and BgHCl. Reagents may include 1,1-dimethylbiguanide, 1,1-dimethylbiguanide HCl (DmbgHCl), melamine, melamine HCl, and mixtures thereof.

Other compounds including guanidine with HCl are also suitable, e.g., melamine HCl (MeHCl) and methylammonium Cl may provide similar results. Other guanidine containing compounds that might achieve similar results in this context include triguanides (the basic structure of triguanides is:

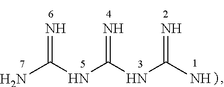

such as carbamimidoylimidodicarbonimidic diamide HCl.

Examples of guanides, biguanides, biguanidines and triguanides that produce similar results include chlorhexidine and chlorohexidine salts, analogs and derivatives, such as chlorhexidine acetate, chlorhexidine gluconate and chlorhexidine hydrochloride, picloxydine, alexidine and polihexanide. Other examples of guanides, biguanides, biguanidines and triguanides that can be used according to the present invention are chlorproguanil hydrochloride, proguanil hydrochloride (currently used as antimalarial agents), metformin hydrochloride, phenformin and buformin hydrochloride (currently used as antidiabetic agents).

As discussed above, guanidine moiety reagents may or may not be complexed with HCl. Reagent complexing with any hydrogen halide may achieve similar results. Guanidine moiety reagents without HCl complexing may also be mixed with other reagents, such as the other reagents discussed in U.S. patent application Ser. No. 17/112,076, herein incorporated by reference in its entirety, having HCl complexing. They may comprise at least one functionality selected from a guanidine, urea, imidazole, and methylammonium. The reagent may be associated with HCl or Cl. The reagent may comprise at least one of guanidine HCl, biguanide HCl, dimethylbiguanide HCl, methylammonium Cl. An important criterion may be whether the reagent or mix of reagents has a liquid phase while decomposing in the temperature ranges of low-temperature nitrocarburization (e.g., 450 to 500° C.). The extent to which reagents evaporate without decomposing before reaching that temperature range is an important consideration.

Reagents used in the treatments disclosed herein include those comprising non-polymeric N/C/H compounds. Mixtures of different non-polymeric N/C/H compounds are included. The non-polymeric N/C/H compounds may supply nitrogen and carbon atoms for case formation, including simultaneous surface hardening, e.g., carburization, nitriding, and/or carbonitriding of the article 210. Mixtures of these compounds can be used to tailor that the particular non-polymeric N/C/H compounds used to the particular operating conditions desired for simultaneous surface hardening. The non-polymeric N/C/H compounds may be used for any surface alteration including hardening and altering any other surface property alteration described herein. Reagent may have non-guanidine additives. List of additives includes but is not limited to: ammonium chloride, urea, melem, melam, imidazole, imidazole HCl, methylamine, methylammonium chloride, dicyandiamide, acetamidine, acetamidine HCl, ethylamine, ethylamine HCl, formamidine, formamidine HCl, and mixtures thereof.

The non-polymeric N/C/H compounds that may be used in treatments disclosed herein can be a compound which (a) contains at least one carbon atom, (b) contains at least one nitrogen atom, (c) contains only carbon, nitrogen, hydrogen and optionally halogen atoms, (d) is solid or liquid at room temperature (25° C.) and atmospheric pressure, and (e) has a molecular weight of ≤5,000 Daltons. Non-polymeric N/C/H compounds with molecular weights of ≤2,000 Daltons. ≤1,000 Daltons or even ≤500 Daltons are included. Non-polymeric N/C/H compounds which contain a total of 4-50 C+N atoms, 5-50 C+N atoms, 6-30 C+N atoms, 6-25 C+N atoms, 6-20 C+N atoms, 6-15 C+N atoms, and even 6-12 C+N atoms, are included.

Specific classes of non-polymeric N/C/H compounds that can be used with the disclosed treatments include primary amines, secondary amines, tertiary amines, azo compounds, heterocyclic compounds, ammonium compounds, azides and nitriles. Of these, those which contain 4-50 C+N atoms are desirable. Those which contain 4-50 C+N atoms, alternating C═N bonds and one or more primary amine groups are included. Examples include melamine, aminobenzimidazole, adenine, benzimidazole, guanidine, biguanide, triguanide, pyrazole, cyanamide, dicyandiamide, imidazole, 2,4-diamino-6-phenyl-1,3,5-triazine (benzoguanamine), 6-methyl-1,3,5-triazine-2,4-diamine (acetoguanamine). 3-amino-5,6-dimethyl-1,2,4-triazine, 3-amino-1,2,4-triazine, 2-(aminomethyl)pyridine, 4-(aminomethyl)pyridine, 2-amino-6-methylpyridine and 1H-1,2,3-triazolo(4,5-b)pyridine, 1,10-phenanthroline, 2,2′-bipyridyl and (2-(2-pyridyl)benzimidazole). Specific triguanides include 1,3-bis(diaminomethylidene)guanidine and N-carbamimidoylimidodicarbonimidic diamide.

Also included are the three triazine isomers, as well as various aromatic primary amines containing 4-50 C+N atoms such as 4-methylbenzeneamine (p-toluidine), 2-methylaniline (o-toluidine), 3-methylaniline (m-toluidine), 2-aminobiphenyl, 3-aminobiphenyl, 4-aminobiphenyl, 1-naphthylamine, 2-naphthylamine, 2-aminoimidazole, and 5-aminoimidazole-4-carbonitrile. Also included are aromatic diamines containing 4-50 C+N atoms such as 4,4′-methylene-bis(2-methylaniline), benzidine, 4,4′-diaminodiphenylmethane, 1,5-diaminonaphthalene, 1,8-diaminonaphthalene, and 2,3-diaminonaphthalene. Hexamethylenetetramine, benzotriazole and ethylene diamine are also included.

Any reagent described herein may be associated with HCl. HCl, in some cases, may assist in de-passivation or other chemical process. In some cases, HCl association may increase the reagent phase change temperatures.

Yet another included class of compounds, in which some of the above compounds are included, are those which form nitrogen-based chelating ligands, e.g., guanidine moieties and polydentate ligands containing two or more nitrogen atoms arranged to form separate coordinate bonds with a single central metal atom. Compounds forming bidentate chelating ligands of this type are included. Examples include o-phenantrolin, 2,2′-bipyridine, aminobenzimidazol and guanidinium chloride. In addition to [HNC(NH₂)₂], guanidine moieties can be more generally represented with [R—(H₂NC═NH)]. Urea moieties with [R—NH(H₂NC=0)] are included.

Still another included type of non-polymeric N/C/H compounds are those used to produce carbon nitrides and/or carbon nitride intermediate(s) described in WO 2016/027042, the disclosure of which is incorporated herein in its entirety. The intermediate species may participate in or contribute to low-temperature activation and hardening of a article 210. Precursors, which can include melamine and GuHCl, can form various carbon nitride species. These species, which have the empirical formula C₃N₄, comprises stacked layers or sheets one atom thick, which layers are formed from carbon nitride in which there are three carbon atoms for every four nitrogen atoms. Solids containing as little as 3 such layers and as many as 1000 or more layers are possible. Although carbon nitrides are made with no other elements being present, doping with other elements is contemplated.

Yet another included subgroup of non-polymeric N/C/H compounds included are those which contain 20 or less C+N atoms and at least 2 N atoms.

In some instances, at least 2 of the N atoms in these compounds are not primary amines connected to a 6-carbon aromatic ring, either directly or through an intermediate aliphatic moiety. In other words, although one or more of the N atoms in these particular non-polymeric N/C/H compounds can be primary amines connected to a 6-carbon aromatic ring, at least two of the N atoms in these compounds should be in a different form, e.g., a secondary or tertiary amine or a primary amine connected to something other than a 6-carbon aromatic ring.

The N atoms in the non-polymeric N/C/H compounds of this subgroup (i.e., non-polymeric N/C/H compounds containing 20 or less C+N atoms and at least 2 N atoms) can be connected to one another such as occurs in an azole moiety, but more commonly will be connected to one another by means of one or more intermediate carbon atoms. Urea may also be included.

Of the non-polymeric N/C/H compounds of this subgroup, those which contain 15 or less C+N atoms, as well as those which contain at least 3 N atoms are included. Those that contain 15 or less C+N atoms and at least 3 N atoms are included.

The non-polymeric N/C/H compounds of this subgroup can be regarded as having a relatively high degree of nitrogen substitution. In this context, a relatively high degree of nitrogen substitution will be regarded as meaning the N/C atomic ratio of the compound is at least 0.2. Compounds with N/C atomic ratios of 0.33 or more, 0.5 or more, 0.66 or more, 1 or more, 1.33 or more, or even 2 or more are included. Non-polymeric N/C/H compounds with N/C atom ratios of 0.25-4, 0.3-3, 0.33-2, and even 0.5-1.33 are included.

Non-polymeric N/C/H compounds of this subgroup containing 10 or less C+N atoms are included, especially those in which the N/C atomic ratio is 0.33-2, and even 0.5-1.33.

Non-polymeric N/C/H compounds of this subgroup which contain 8 or less C+N atoms are included, especially those in which the N/C atomic ratio is 0.5-2 or even 0.66-1.5, in particular triguanide-based reagents.

In order to achieve this relatively high degree of nitrogen substitution, the non-polymeric N/C/H compounds of this subgroup can include one or more nitrogen-rich moieties examples of which include imine moieties [C═NR], cyano moieties [—CN] and azo moieties [R—N═N—R]. These moieties can be a part of a 5- or 6-membered heterocyclic ring containing one or more additional N atoms such as occurs when an imine moiety forms a part of an imidazole or triazine group or when an azole moiety forms a part of a triazine or triazole group.

These moieties can also be independent in the sense of not being part of a larger heterocyclic group. If so, two or more of these moieties can be connected to one another through an intermediate C and/or N atom such as occurs, for example, when multiple imine moieties are connected to one another by an intermediate N atom such as occurs in 1,1-dimethylbiguanide hydrochloride or when a cyano group is connected to an imine moiety through an intermediate N atom such as occurs in 2-cyanoguanidine. Alternatively, they can simply be pendant from the remainder of the molecule such as occurs in 5-aminoimidazole-4-carbonitrile or they can be directly attached to a primary amine such as occurs in 1,1-dimethylbiguanide hydrochloride, formamidine hydrochloride, acetamidine hydrochloride, 2-cyanoguanidine, cyanamide and cyanoguanidine monohydrochloride.

In the non-polymeric N/C/H compounds that contain one or more secondary amines, the secondary amine can be part of a heterocyclic ring containing an additional 0, 1 or 2 N atoms. An example of such compounds in which the secondary amine is part of a heterocyclic ring containing no additional N atoms is 1-(4-piperidyl)-1H-1,2,3-benzotriazole hydrochloride. Examples of such compounds in which the heterocyclic ring contains one additional N atom are 2-aminobenzimidazole, 2-aminomethyl benzimidazole dihydrochloride, imidazole hydrochloride and 5-aminoimidazole-4-carbonitrile. An example of such compounds in which the secondary amine is part of a heterocyclic ring containing two additional N atoms is benzotriazole. Alternatively, the secondary amine can be connected to a cyano moiety such as occurs in 2-cyanoguanidine and cyanoguanidine monohydrochloride.

In the non-polymeric N/C/H compounds of this subgroup which contain one or more tertiary amines, the tertiary amine can be part of a heterocyclic ring containing an additional 1 or 2 N atoms, an example of which is 1-(4-piperidyl)-1H-1,2,3-benzotriazole hydrochloride.

In some variations, the non-polymeric N/C/H compound used will contain only N, C and H atoms. The particular non-polymeric N/C/H compound used will be halogen-free. In other aspects of the present disclosure, the non-polymeric N/C/H compound can contain or be associated or complexed with one or more optional halogen atoms.

One way this can be done is by including a hydrohalide acid such as HCl in the compound in the form of an association or complex. If so, this non-polymeric N/C/H compounds is referred to in this disclosure as being “complexed.” On the other hand, if the non-polymeric N/C/H compound has not been complexed with such an acid, then it is referred to in this disclosure as being “uncomplexed.” In those instances in which neither “complexed” nor “uncomplexed” is used, it will be understood that the term in question refers to both complexed and uncomplexed non-polymeric N/C/H compounds.

The non-polymeric N/C/H compounds of the present disclosure can be complexed with a suitable hydrohalide acid such as HCl and the like (e.g., HF, HBr and HI), if desired. In this context, “complexing” will be understood to mean the type of association that occurs when a simple hydrohalide acid such as HCl is combined with a nitrogen-rich organic compound such as 2-aminobenzimidazole. Although the HCl may dissociate when both are dissolved in water, the 2-aminobenzimidazole does not. In addition, when the water evaporates, the solid obtained is composed of a mixture of these individual compounds on an atomic basis—e.g., a complex. It is not composed exclusively of a salt in which Cl— anions from the HCl are ionically bound to N atoms in the 2-amionbenzimidazole which N atoms have been made positive by taking up H+ cations derived from the HCl.

### Treatments That May be Applied Using Setup 200

### General Property Altering Treatments

Treatments referred to below may be applied before, after, or during the application of laser light 222 and/or powder/gas 224 via setup 200. In one example, a treatment described below (e.g., hardening) may be applied after a reagent in powder/gas 224 has been applied to surface 210a and chemically activated via laser 222. In another, a treatment described below may be applied while reagent in powder/gas 224 is being applied to surface 210a and/or reagent is activated via laser 222. It is to be understood that other variations are within the scope of the present disclosure.

Treatments disclosed herein may alter the mechanical, chemical, and electrical properties of the article 210 surface 210a. Such treatments may also alter thermodynamic, bioactive and/or magnetic properties of the article 210 surface 210a. Treatments, including for example applying reagents disclosed herein, may activate the surface for any of the hardening processes disclosed herein. Treatments may block portions of the surface from applications of other treatments and/or exposure to liquid or gaseous species. One example is a metal (e.g., copper) treatment that prevents portions from exposure to, for example, vapors, such as those emanating from the pyrolysis of a chemical reagent (e.g., any of the chemical reagents disclosed, described, referenced, or implied herein). The article 210 surface 210a may have one or more treatment types/compositions to apply different properties on different portions of the same article 210.

Exemplary treatments can be applied to impart or increase mechanical or physical properties, including but not limited to hardness, abrasion resistance, and Young's modulus on a surface. Exemplary treatments can be applied to impart improved chemical properties such as corrosion resistance on a surface. They may increase electrical resistance of the surface 210a. They may decrease hydrogen permeability of the surface portion 210a.

Suitable treatments create a non-homogeneous top layer amalgam of iron or nickel-based alloy metal atoms. Some such treatments comprise one or more metallic phases, including at least one or more of austenite, martensite, and ferrite. Some such treatments contain one or more of interstitial carbon atoms, interstitial nitrogen atoms, dispersion of minute metal carbide precipitates, dispersion of minute metal carbide precipitates, dispersion of minute metal nitride precipitates, coarse metal carbide precipitates, and coarse metal nitride precipitates.

After a treatment is applied, a second treatment may use the portion of the article 210 affected by the first treatment to alter properties of the underlying article 210. For example, a heat treatment may cause a reagent to passivate the article 210 for hardening processes, such as nitriding, carburizing, and nitrocarburizing in the hardening processes discussed and/or cited herein by reference. Heating the area affected by the first treatment may also result in the hardening process, e.g., where nitrogen and/or carbon released during treating diffuse into the surface of the article 210 to thereby harden the article 210 surface. Exposing the treated surface to a certain gas or reagent may result in case formation at the surface of the article.

Another treatment that may be applied using setup 200 is cleaning the surface 210a. Such cleaning may be accomplished, in particular, by applying laser light 222 to the surface 210a. Cleaning the surface 210a may also occur by other means (e.g., other types of ablation and/or mechanical cleaning) prior to the applying reagent and the applying laser light. More generally, cleaning the surface 210a may include cleaning by laser 222, cleaning by heating (via laser 222 or otherwise), cleaning by resistive heating, cleaning by induction, cleaning by convection, e-beam cleaning, and cleaning by reactive means.

### Hardening Treatments

One of the property altering treatments disclosed herein includes methods of hardening the article 210. The present disclosure may facilitate and/or execute any hardening process described explicitly herein, and/or implied, or incorporated by reference. Such hardening processes may include interstitial infusion and/or diffusion of atomic species. Such hardening processes include any that harden steel or alloys using nitrogen and/or carbon diffusion. Hydrogen diffusion may also be part of these treatments. These treatments include conventional carburization, nitriding, carbonitriding, and nitrocarburization and low-temperature carburization, nitriding, carbonitriding, and nitrocarburization. They include hardening processes involving the use of reagents or other chemicals, as described herein. The reagents may activate the metal for hardening, for example by rendering a passivation layer such that it allows diffusion of nitrogen and/or carbon. Treatments disclosed herein may also be used in hardening processes that do not involve the diffusion of carbon or nitrogen (e.g., mechanical working techniques). Treatments described herein may be compatible with one or more of these hardening processes, wherein the processes are performed simultaneously and/or in concert. In some cases, processes described herein may also be used to prevent or deter hardening, and/or other physical, chemical, and electrical processes, on certain portions of article 210.

More than one hardening treatment described herein may be performed. The hardening treatments may be applied simultaneously, sequentially, or alternately phased or pulsed regarding nitrogen and carbon introduction, for example. They may be applied in conjunction with any other treatment described herein, including the property altering treatments described above.

The hardening and/or property altering treatments may form a case or case-hardened outer layer. That layer may increase and/or improve at least one of hardness, corrosion resistance, and abrasion resistance. It may change other properties of the surface, with or without case formation, including but not limited to, mechanical properties, elasticity, magnetic properties, thermodynamic properties, bioactive properties, electrical properties, and mass density.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1-42. (canceled)

43. A method for treating an article made of self-passivating metal to improve the surface properties of the metal including:
applying reagent to a surface portion of the article; and
applying laser light to the surface portion of the article to chemically activate the reagent, wherein the chemical activating of the reagent treats the surface portion thereby modifying one or more property of the surface portion.

44. The method of claim 43, wherein applying the reagent comprises at least one of applying the reagent via:
at least one of a jet of powder, a jet of liquid, or a jet of vapor;
a high-pressure nozzle using inert gas;
a voltage potential difference between reagent and surface portion;
a micro head flow jet; and
a 3D electronic printer system.

45. The method of claim 43 further comprising the applying the reagent and applying the laser light to another surface portion of the article.

46. The method of claim 43, wherein the reagent comprises at least one of a guanidine functionality and a halide association.

47. The method of claim 43, wherein the guanidine functionality comprises guanidium chloride, biguanide, biguanide HCl, 1,1-dimethylbiguanide, and 1,1-dimethylbiguanide HCl.

48. The method of claim 43, wherein the reagent comprises at least one of ammonium chloride, urea, melem, melam, imidazole, imidazole HCl, methylamine, methylammonium chloride, dicyandiamide, acetamidine, acetamidine HCl, ethylamine, ethylamine HCl, formamidine, and formamidine HCl.

49. The method of any one of claim 1, wherein the laser light is co-linear coherent laser light.

50. The method of claim 43, wherein a laser that produces the laser light comprises at least one of:
a fiber optic laser;
a gas laser;
an excimer laser;
an exciplex laser;
a liquid-based laser;
a dye-based laser;
a chemical laser;
a solid state laser;
a chemical laser;
a semiconductor laser;
a diode-based laser;
an infrared laser; and
an ultraviolet laser.

51. The method of claim 50, wherein at least one of:
the gas laser comprises at least one of a CO₂ laser and a helium-neon laser;
the solid state laser comprises at least one of a yttrium aluminum garnet (YAG) laser, a ruby laser, a soprano titanium laser, a soprano ice laser, and a titanium sapphire laser;
the surface portion has a surface area on order of mm² or microns²;
heating created by the laser in the surface portion is confined to the surface area;
heating created by the laser in the surface portion is includes an area between the laser source and the surface area;
the heating caused by the laser is insufficient to cause grain growth; and
the heating caused by the laser is sufficient to cause pyrolysis of the reagent.

52. The method of claim 51 further comprising introducing an inert gas into an environment of the article prior to or simultaneously with the heating.

53. The method of claim 52, wherein the inert gas prevents oxidizing of the surface portion.

54. The method of claim 43, wherein at least one of:
the applying reagent and the applying laser light are performed simultaneously;
the applying the laser light causes a chemical reaction in the article;
the applying the reagent does not coat the article; and
the reagent is recycled for more efficient use.

55. The method of claim 43, wherein at least one of:
a pressure in an environment of the article is 1 ATM or above; and
the treating comprises hardening the article.

56. The method of claim 43, further comprising at least one of:
interstitial infusion and diffusion of atomic hydrogen, carbon, and nitrogen into the surface portion;
increasing abrasion resistance of the surface portion;
increasing corrosion resistance of the surface portion;
increasing a Youngs modulus of the surface portion;
increasing electrical resistance of the surface portion; and
decreasing hydrogen permeability of the surface portion.

57. The method of claim 56, wherein at least one of:
the applying reagent and the applying laser light minimize carbide and nitride precipitation in the surface portion;
any carbide and nitride precipitates produced during the applying reagent and the applying laser light are finely dispersed;
the treating of the metal occurs in one minute or less; and
the treating of the metal occurs while the article is in at least one of a machining and fabrication process.

58. The method of claim 43, wherein at least one of:
the method further comprises cleaning the surface portion prior to the applying reagent and the applying laser light;
the cleaning the surface portion comprises at least one of cleaning by laser, cleaning by heating, cleaning by resistive heating, cleaning by induction, cleaning by induction, cleaning by convection, e-beam cleaning, and cleaning by reactive means;
the article comprises self-passivating metal;
the article further comprises a stainless steel having 5-50 wt. % Ni and at least 10 wt. % Cr, a nickel-based alloy, and a cobalt-based alloy;
the article further comprises a high-manganese stainless steel having at least 10 wt. % Cr or a titanium-based alloy;
the article further comprises at least one of the following steel alloys: 316L, 6Mo, 6HN, Incoloy 825, Inconel 625, Hastelloy C22, and Hastelloy C276;
the surface portion has a coherent protective coating;
the coherent protective coating is a passivation layer formed either from chromium oxide or titanium oxide;
the article has a Beilby layer;
the article is at least one of wrought, formed, and forged; and
the article is additively manufactured.

59. An article prepared according to the method of claim 43.

60. The article of claim 59, wherein the article is additively manufactured.

61. An apparatus for performing the method of claim 43.

62. A system for performing the method of claim 43.
